(19) United States
(12) Patent Application Publication
(10) Pub. No.: US 2026/0004550 A1
(43) Pub. Date: Jan. 1, 2026

(54) METHOD FOR EXTRACTING BOUNDARY LINE OF ON-YEAR AND OFF-YEAR MOSO BAMBOO FORESTS BASED ON SENTINEL-2 REMOTE SENSING DATA

(71) Applicant: CHUZHOU UNIVERSITY, Chuzhou, Anhui (CN)

(72) Inventors: Nan LI, Chuzhou, Anhui (CN); Longwei LI, Chuzhou, Anhui (CN); Huizi ZHU, Chuzhou, Anhui (CN); Wei ZHANG, Chuzhou, Anhui (CN)

(21) Appl. No.: 18/847,827

(22) PCT Filed: Nov. 13, 2023
(86) PCT No.: PCT/CN2023/131250

§ 371 Date: Jul. 25, 2025

(30) Foreign Application Priority Data
Jan. 10, 2023 (CN) 202310035803.X

(51) Int. Cl. G06V 10/44; G06T 7/13; G06V 10/74; G06V 10/764; G06V 20/10

(52) U.S. Cl. CPC G06V 10/44; G06T 7/13; G06V 10/761; G06V 10/764; G06V 20/188; G06T 2207/30188

(57) ABSTRACT

Disclosed is a method for extracting a boundary line of on-year and off-year moso bamboo forests based on Sentinel-2 remote sensing data, and relates to the technical field of forestry remote sensing. The method includes classifying remote sensing images to acquire spatial distribution of three land type results, the three land type results including several on-year moso bamboo forests, several off-year moso bamboo forests and other vegetations between the on-year and off-year moso bamboo forests; extracting an initial boundary line of the on-year and off-year moso bamboo forests according to spatial distribution of three land type results; building a buffer region of the initial boundary line, and acquiring intersecting pixels of the buffer region and the spatial distribution of three land type results; and calculating pixel thresholds by using the intersecting pixels, and acquiring a final boundary line of the on-year and off-year moso bamboo forests. Using the above method can accurately obtain the boundary line between on-year and off-year of moso bamboo forests.

### TECHNICAL FIELD

The disclosure relates to the technical field of forestry remote sensing, and more particularly, relates to a method for extracting a boundary line of on-year and off-year moso bamboo forests based on Sentinel-2 remote sensing data.

### BACKGROUND

Moso bamboo forests have an on-year and off-year phenomenon. That is, there are temporal difference features of high yield in a first year (on year) and low yield in a next year (off year) in the same land type. Studies have shown that there are also spatial difference features in an on year and off year, that is, there are different morphological characteristics of on-year moso bamboos and off-year moso bamboos in adjacent plots at the same time (in the same month), and there is a clear boundary line between the on-year moso bamboo forests and the off-year moso bamboo forests. These temporal and spatial differences of moso bamboo forests bring great challenges to the monitoring of the moso bamboo forests. Differences are generated between the soil quality and root system development in the moso bamboo forests in different growth states and the natural supply above the forests, in a case of being lack of reasonable management, expansion to adjacent forest communities may easily occur, and thus obvious influence may be caused on forest ecological system balance and moso bamboo resource economy.

At present, there has been no specific analysis method for boundary line extraction of on-year and off-year moso bamboo forests and landscape research.

Therefore, how to realize the boundary line extraction of on-year and off-year moso bamboo forests by using remote sensing images is a problem needing to be solved by persons skilled in the art.

### SUMMARY

In view of this, the disclosure provides a method for extracting a boundary line of on-year and off-year moso bamboo forests based on Sentinel-2 remote sensing data. The method can extract a boundary line of the on-year and off-year moso bamboo forests in the same time period, and provides references for moso bamboo ecological system monitoring.

In order to achieve the above objective, the disclosure adopts the following technical solution:

A method for extracting a boundary line of on-year and off-year moso bamboo forests based on Sentinel-2 remote sensing data includes the following steps:
classifying remote sensing images of regions to be extracted to acquire spatial distribution regions of three land type results, the three land type results including several on-year moso bamboo forests, several off-year moso bamboo forests and other vegetations between the on-year moso bamboo forests and the off-year moso bamboo forests;
extracting an initial boundary line of the on-year moso bamboo forests and the off-year moso bamboo forests according to the spatial distribution regions of three land type results;
building a buffer region of the initial boundary line, and acquiring intersecting pixels of the buffer region and the spatial distribution regions of three land type results; and
calculating pixel thresholds according to the intersecting pixels, and acquiring a final boundary line of the on-year moso bamboo forests and the off-year moso bamboo forests according to pixel threshold results.

Preferably, the classifying remote sensing images of regions to be extracted to acquire spatial distribution regions of three land type results specifically includes:
acquiring multi-period remote sensing images of the regions to be extracted for two consecutive years, and performing preprocessing, the preprocessing including radiometric calibration, atmospheric correction, waveband resampling, waveband fusion and boundary clipping;
according to the preprocessed multi-period remote sensing images, respectively calculating a Normalized Difference Vegetation Index (NDVI) of each period of remote sensing images, counting a ratio of number of occurrences of regions with NDVI values being greater than a set threshold in each period of remote sensing images, and if the ratio is greater than a preset value, dividing corresponding regions in the remote sensing images into a spatial distribution region of evergreen vegetations;
for the spatial distribution region of evergreen vegetations, selecting images in May to calculate an OYML index and an FYML index of the remote sensing images, specifically including:

$$OYML = {( VRE {2}_{i - 1} - VRE {2}_{i} )}^{2} \times \frac{VRE {2}_{i} + VRE {3}_{i}}{VRE {2}_{i - 1} + VRE {3}_{i - 1}}$$

$$FYML = {( VRE {2}_{i - 1} - VRE {2}_{i} )}^{2} \div \frac{VRE {2}_{i} + VRE {3}_{i}}{VRE {2}_{i - 1} + VRE {3}_{i - 1}}$$

wherein in the formulas, VRE2ᵢ represents reflectivity of red edge 2 band in same-period remote sensing images in i^{th} year; VRE2ᵢ₋₁ represents reflectivity of red edge 2 band in same-period remote sensing images in (i−1)^{th} year; VRE3ᵢ represents reflectivity of red edge 3 band in same-period remote sensing images in i^{th} year; and VRE3ᵢ₋₁ represents reflectivity of red edge 3 band in same-period remote sensing images in (i−1)^{th} year;
determining spatial distribution regions with the OYML index being greater than 0.01 in same-period remote sensing images in i^{th} year as regions of on-year moso bamboo forests;
determining spatial distribution regions with the FYML index being greater than 0.01 in the same-period remote sensing images in i^{th} year as regions of off-year moso bamboo forests; and
determining spatial distribution regions meeting 0.005<OYML<0.01 and 0.005<FYML<0.01 in the same-period remote sensing images in i^{th} year as regions of other vegetations.

Preferably, the extracting an initial boundary line of the on-year moso bamboo forests and the off-year moso bamboo forests according to the spatial distribution regions of three land type results specifically includes:
acquiring raster data of the spatial distribution regions of three land type results;
merging raster data of the on-year moso bamboo forests and raster data of other vegetations;
converting the merged raster data and raster data of the off-year moso bamboo forests into vector data through spatial data processing;
acquiring coincidence lines of merged vector data and line vector data of the off-year moso bamboo forests; and
extracting a center line of the acquired coincidence lines, and eliminating interfering coincidence lines to acquire the initial boundary line of the on-year moso bamboo forests and the off-year moso bamboo forests.

Preferably, the calculating pixel thresholds by using the intersecting pixels, and acquiring a final boundary line of the on-year moso bamboo forests and the off-year moso bamboo forests according to pixel threshold results specifically includes:
respectively acquiring areas of the intersecting pixels of the three land type results and the buffer region;
calculating the pixel thresholds according to the areas of the intersecting pixels:

$$Δ {S}_{on - off 1} = \frac{a + b}{a + b + c}$$

$$Δ {S}_{on - off 2} = \frac{b}{c}$$

wherein in the formulas, ΔS_{on-off1} represents a first pixel threshold; ΔS_{on-off2} represents a second pixel threshold; a represents an area of intersecting pixels of the buffer region and the on-year moso bamboo forests; b represents an area of intersecting pixels of the buffer region and the off-year moso bamboo forests; and c represents an area of intersecting pixels of the buffer region and other vegetations; and
setting the first pixel threshold ΔS_{on-off1} and the second pixel threshold ΔS_{on-off2} to simultaneously meet:
determining the initial boundary line meeting ΔS_{on-off1}>0.5 and ΔS_{on-off2}>0.7 as the final
boundary line of the on-year moso bamboo forests and the off-year moso bamboo forests.

Preferably, the acquiring a final boundary line of the on-year moso bamboo forests and the off-year moso bamboo forests according to pixel threshold results further includes:
performing verification and local modification on the final boundary line by using boundary line data of the on-year moso bamboo forests and the off-year moso bamboo forests acquired by high resolution images of Google Earth Pro software.

Preferably, the method further includes:
performing vertical landscape analysis and horizontal landscape analysis by using the final boundary line of the on-year moso bamboo forests and the off-year moso bamboo forests.

Preferably, the performing vertical landscape analysis by using the final boundary line of the on-year moso bamboo forests and the off-year moso bamboo forests specifically includes:
acquiring altitude data of remote sensing images, and converting the final boundary line of the on-year moso bamboo forests and the off-year moso bamboo forests into point data;
overlapping the altitude data with the point data converted from the final boundary line, and extracting topographic data of each of the point data on the final boundary line, the topographic data including altitude, slope and aspect;
reclassifying the topographic data; and
acquiring the reclassified topographic data, and counting the frequency distribution of the altitude and slope of each of the point data of the final boundary line in different aspects and analyzing feature changes of the topographic data by using an ArcGIS spatial analysis method.

Preferably, the performing horizontal landscape analysis by using the final boundary line of the on-year moso bamboo forests and the off-year moso bamboo forests specifically includes:
acquiring altitude data of remote sensing images, and extracting altitude information of residential areas from the altitude data;
converting the final boundary line of the on-year moso bamboo forests and the off-year moso bamboo forests into point data, overlapping the converted point data with the altitude data, and extracting a lowest point on the final boundary line;
acquiring a relative height difference and a horizontal distance between the lowest point on the final boundary line and a nearest residential area; and
calculating a theoretical distance between the lowest point on the final boundary line and the residential area according to the relative height difference and the horizontal distance.

Through the above technical solution, it can be known that compared with the prior art, the disclosed method for extracting a boundary line of on-year and off-year moso bamboo forests based on Sentinel-2 remote sensing data has the following beneficial effects:

The boundary line of the on-year and off-year moso bamboo forests is extracted by using Sentinel-2 remote sensing data. The technical solution is simple and feasible, operation parameters are few, and robustness is high. The boundary line result of the on-year and off-year moso bamboo forests can be accurately acquired, and references can be provided for moso bamboo ecological system monitoring.

### BRIEF DESCRIPTION OF FIGURES

In order to describe the technical solution of embodiments of the disclosure or in the prior art more clearly, figures to be used in embodiments or in the prior art are briefly introduced. Obviously, figures described hereafter are only some embodiments of the disclosure. For a person of ordinary skill in the art, other figures can also be obtained according to these provided figures without any inventive efforts.

FIG. 1 is a schematic flow chart of a method for extracting a boundary line of on-year and off-year moso bamboo forests based on Sentinel-2 remote sensing data and application according to an embodiment of the disclosure.

FIG. 2 is a schematic diagram of an image obtained based on an OYML index according to an embodiment of the disclosure.

FIG. 3 is a schematic diagram of an image obtained based on an FYML index according to an embodiment of the disclosure.

FIG. 4 is plot classification processing results on remote sensing images according to an embodiment of the disclosure, and the classification results include an on-year moso bamboo forest land type, an off-year moso bamboo forest land type and other vegetation land type.

FIG. 5 is an overlapping expression of an output boundary line vector diagram of on-year and off-year moso bamboo forests on remote sensing images according to an embodiment of the disclosure.

FIG. 6 is a general distribution change result diagram of a boundary line obtained by performing vertical landscape analysis on the boundary line of on-year and off-year moso bamboo forests at altitude and slope according to an embodiment of the disclosure.

FIG. 7 is a frequency distribution result diagram of a boundary line obtained by performing vertical landscape analysis on the of on-year and off-year boundary line moso bamboo forests at altitude and slope in different aspects according to an embodiment of the disclosure.

FIG. 8 is a response analysis result diagram of a boundary line to human activities obtained by performing horizontal landscape analysis on the boundary line of on-year and off-year moso bamboo forests according to an embodiment of the disclosure.

### DETAILED DESCRIPTION

The technical solution in embodiments of the disclosure will be clearly and completely described hereinafter with reference to the accompanying drawings in the embodiments of the disclosure. Obviously, the described embodiments are only a few, but not all, embodiments of the disclosure. Based on the embodiments of the disclosure, all other embodiments obtained by a person of ordinary skill in the art without making any creative effort are within the protection scope of the disclosure.

An embodiment of the disclosure discloses a method for extracting a boundary line of on-year and off-year moso bamboo forests based on Sentinel-2 remote sensing data. The method includes the following steps:

classifying remote sensing images of regions to be extracted to acquire spatial distribution regions of three land type results, the three land type results including several on-year moso bamboo forests, several off-year moso bamboo forests and other vegetations between the on-year moso bamboo forests and the off-year moso bamboo forests;
extracting an initial boundary line of the on-year moso bamboo forests and the off-year moso bamboo forests according to the spatial distribution regions of three land type results;
building a buffer region of the initial boundary line, and acquiring intersecting pixels of the buffer region and the spatial distribution regions of three land type results; and
calculating pixel thresholds according to the intersecting pixels, and acquiring a final boundary line of the on-year moso bamboo forests and the off-year moso bamboo forests according to pixel threshold results.

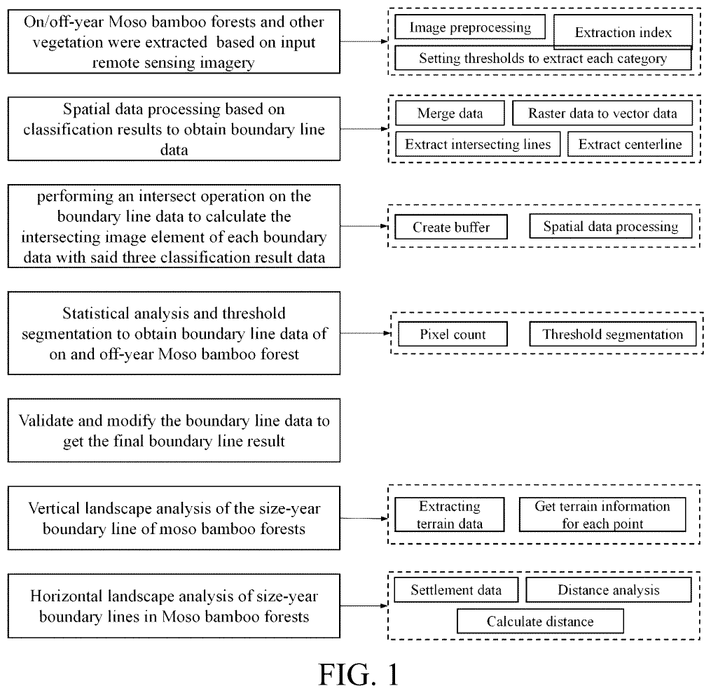

The above steps will be illustrated in detail hereafter in combination with specific implantations. As shown in FIG. 1, in a specific embodiment, the method includes the following steps:
Step a: remote sensing images of regions to be extracted are acquired, and the acquired remote sensing images are interpreted to extract three land type results including on-year moso bamboo forests, off-year moso bamboo forests and other vegetations. This step specifically includes:
Step a1: multi-period Sentinel-2 remote sensing images are acquired for at least two consecutive years, and the Sentinel-2 data is preprocessed. The preprocessing specifically includes radiometric calibration, atmospheric correction, resampling, inlaying and clipping.

Specifically, Level-1C data in Sentinel-2 may be subjected to radiometric calibration and atmospheric correction by using SNAP-Sen2Cor software to acquire ground feature real reflectivity and to obtain Level-2A data. Wavebands with a 20 m spatial resolution are resampled to reach 10 m by using a cubic convolution method with SNAP software. Ten wavebands: B2\B3\B4\B5\B6\B7\B8\B8A\B11\B12 after resampling are selected to be merged, and administrative boundary vector data is used for clipping to acquire final remote sensing image data for extracting on-year and off-year distribution of moso bamboo forests.
Step a2: for the preprocessed remote sensing image data, a Normalized Difference Vegetation Index (NDVI) of each period of remote sensing images is calculated, and regions in the remote sensing images are divided into evergreen vegetation regions and non-evergreen vegetation regions.

In this disclosure, we consider that the on-year moso bamboo forests, the off-year moso bamboo forests and the other vegetations between the on-year and off-year moso bamboo forests are all belong to evergreen vegetations. At the same time, the non-evergreen vegetations include buildings, water areas and non-green vegetation covering regions. NDVI values are calculated first, regions in the remote sensing images are divided into evergreen vegetation regions and non-evergreen vegetation regions according to results of the NDVI values by using a frequency statistical method.

A ratio of number of occurrences of regions with NDVI values being greater than a set threshold in each period of remote sensing images is counted. If the ratio is greater than a preset value, corresponding regions in the remote sensing images are divided into a spatial distribution region of evergreen vegetations. Specifically, supposed that the threshold is set to be 0.3, a raster value with an NDVI value being greater than 0.3 in the remote sensing images is set to be 1, a raster value with an NDVI value being smaller than 0.3 is set to be 0, the preset value of the ratio in this embodiment is 0.9, regional plots corresponding to the ratio of number of occurrences N>0.9 with NDVI values being greater than the set threshold 0.3 in each period of remote sensing images are divided into evergreen vegetations regions to participate in a next round of further classification of on-year moso bamboo forests, off-year moso bamboo forests and other vegetations, and regional plot information with N being smaller than or equal to 0.9 is eliminated.

$$N = \frac{{N}_{1}}{{N}_{total}}$$

In the formula, N₁ represents the number of occurring times of regions with an NDVI value being greater than 0.3 in multi-period remote sensing images, and Nₜₒₜₐₗ represents a total quantity of the multi-period remote sensing images in two consecutive years.

Based on the spatial distribution region of evergreen vegetations, images in May are selected to calculate an OYML index and an FYML index of the remote sensing images, and the OYML index and the FYML index of the remote sensing images may be specifically calculated according to the following formulas:

$$OYML = {( VRE {2}_{i - 1} - VRE {2}_{i} )}^{2} \times \frac{VRE {2}_{i} + VRE {3}_{i}}{VRE {2}_{i - 1} + VRE {3}_{i - 1}}$$

$$FYML = {( VRE {2}_{i - 1} - VRE {2}_{i} )}^{2} \div \frac{VRE {2}_{i} + VRE {3}_{i}}{VRE {2}_{i - 1} + VRE {3}_{i - 1}}$$

In the formulas, VRE2ᵢ represents reflectivity of red edge 2 band (electromagnetic wave length: 733 nm to 748 nm) in same-period remote sensing images in i^{th} year; VRE2ᵢ₋₁ represents reflectivity of red edge 2 band in same-period remote sensing images in (i−1)^{th} year; VRE3ᵢ represents reflectivity of red edge 3 band (electromagnetic wave length: 773 nm to 793 nm) in same-period remote sensing images in i^{th} year; and VRE3ᵢ₋₁ represents reflectivity of red edge 3 band in same-period remote sensing images in (i−1)^{th} year.

According to the calculation results of the OYML index and the FYML index, spatial distribution regions with an OYML index being greater than 0.01 in same-period remote sensing images in i^{th} year are determined as regions of on-year moso bamboo forests.

Spatial distribution regions with an FYML index being greater than 0.01 in the same-period remote sensing images in i^{th} year are determined as regions of off-year moso bamboo forests.

Spatial distribution regions meeting 0.005<OYML<0.01 and 0.005<FYML<0.01 in the same-period remote sensing images in i^{th} year are determined as regions of other vegetations.

It needs to be pointed out that in embodiments of the disclosure, the OYML index and the FYML index are always set to be a null value under other conditions other than the above results, and do not participate in classification.

In this disclosure, other vegetations between the on-year moso bamboo forests and the off-year moso bamboo forests mainly include other green vegetations between the on-year moso bamboo forests and the off-year moso bamboo forests, and due to existence of other vegetations, there are obvious gaps between the on-year moso bamboo forests and the off-year moso bamboo forests.

Additionally, a classification process for the spatial distribution information of three land type results may be completed by a remote sensing image processing platform ENVI, and may also be completed through other independently researched and developed software.

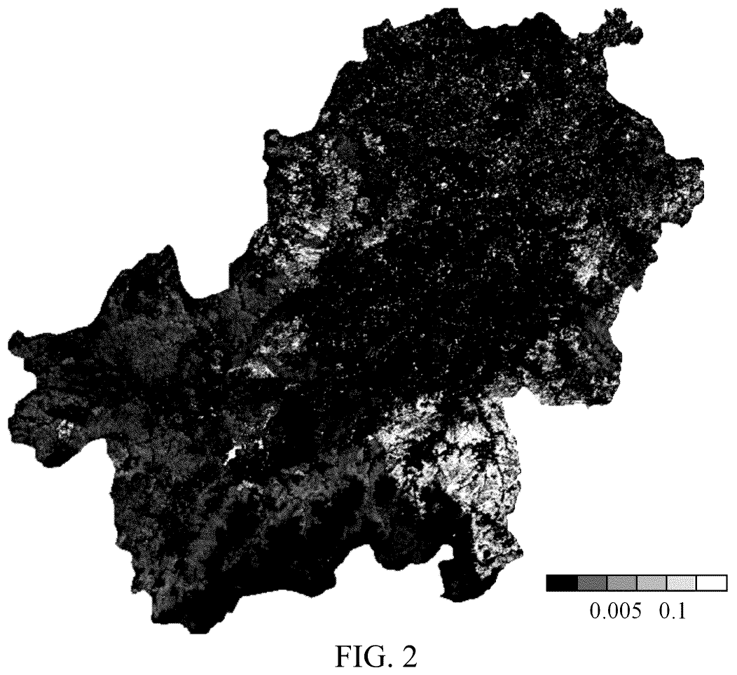

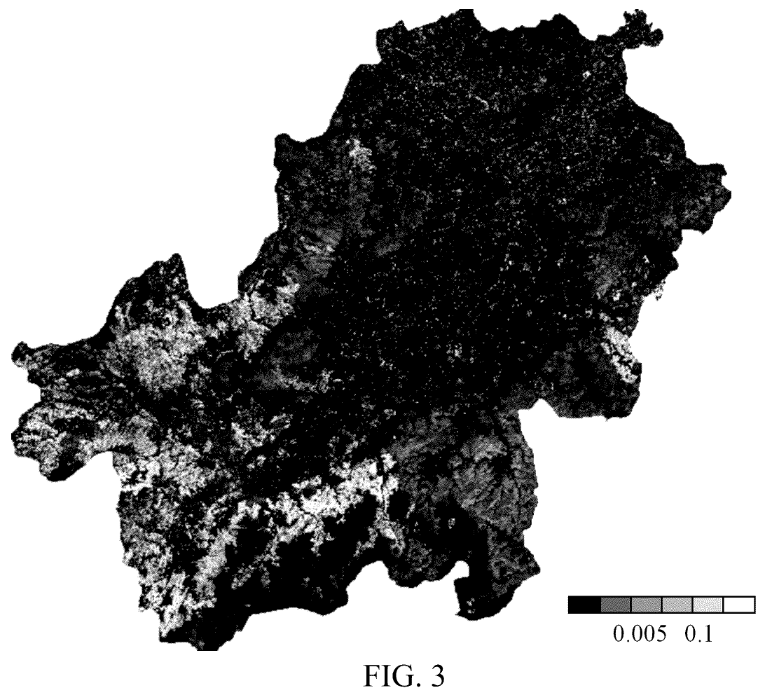

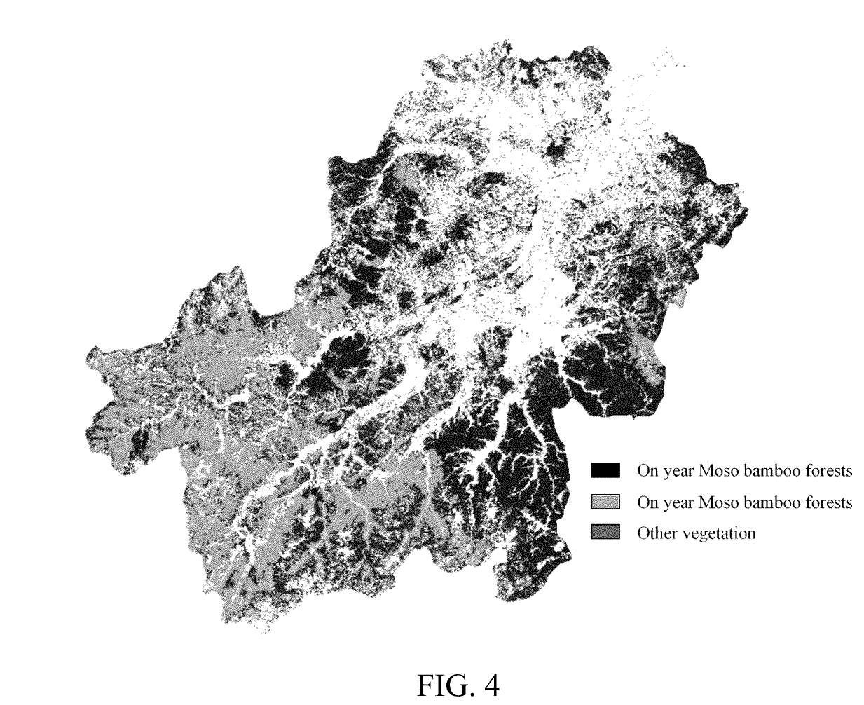

The operation results of the OYML index and FYML index obtained by using the ENVI platform are as shown in FIG. 2 and FIG. 3. The finally extracted three land type results are as shown in FIG. 4.

Step b: an initial boundary line of the on-year moso bamboo forests and the off-year moso bamboo forests is extracted according to the spatial distribution regions of three land type results.

Specifically, in a specific embodiment, based on the extracted land type information, raster data of the on-year moso bamboo forest land types and raster data of other vegetation land types are merged by using a raster calculator tool in ArcGIS. The purpose of merging is to fill the gaps between the spatial distribution regions of the on-year moso bamboo forests and the off-year moso bamboo forests (in other embodiments, a method of merging raster data of the off-year moso bamboo forest land types and raster data of other vegetation land types first may be adopted, and a specific process is basically the same as the subsequent process of merging the raster data of the on-year moso bamboo forests and the raster data of other vegetations first); the merged raster data and raster data of the off-year moso bamboo forests are all converted into vector data through a conversion tool in ArcGIS, and coincidence lines of merged land type vector data of the on-year moso bamboo forests and other vegetations and vector data of the off-year moso bamboo forests are acquired; and a center line of the coincidence lines is extracted by using center line extraction in ArcGIS, short and small interfering coincidence line information is automatically eliminated, and the coincidence line after elimination is the initial boundary line of the on-year moso bamboo forests and the off-year moso bamboo forests.
Step c: a buffer region of the initial boundary line of the on-year moso bamboo forests and the off-year moso bamboo forests is built, and intersecting pixels of the buffer region and the spatial distribution regions of three land type results are acquired.

Specifically, the obtained initial boundary line is subjected to buffer region operation, with a buffer distance of 10 m to 30 m. The buffer data, the land type result of the on-year moso bamboo forests, the land type result of the off-year moso bamboo forests and the land type result of the other vegetations are subjected to spatial data processing by an area tabulating tool in ArcGIS to obtain intersecting pixels of each of line data and data of the three classification results.
Step d: pixel thresholds are calculated by using the intersecting pixels, and a final boundary line of the on-year moso bamboo forests and the off-year moso bamboo forests is acquired according to pixel threshold results.

In a specific embodiment, for intersecting pixel data obtained through area tabulating, a pixel data relationship between the three is calculated in an attribute table by using a raster calculator in ArcGIS, and the result threshold segmentation is performed.

Specifically, the pixel threshold may be calculated by the following formulas:

$$Δ {S}_{on - off 1} = \frac{a + b}{a + b + c}$$

$$Δ {S}_{on - off 2} = \frac{b}{c} .$$

In the formulas, ΔS_{on-off1} represents a first pixel threshold; ΔS_{on-off2} represents a second pixel threshold; a represents an area of intersecting pixels of the buffer region and the on-year moso bamboo forests; b represents an area of intersecting pixels of the buffer region and the off-year moso bamboo forests; and c represents an area of intersecting pixels of the buffer region and other vegetations.

The first pixel threshold ΔS_{on-off1} and the second pixel threshold ΔS_{on-off2} are set to simultaneously meet:
the initial boundary line meeting ΔS_{on-off1}>0.5 and ΔS_{on-off2}>0.7 is determined as the final boundary line of the on-year moso bamboo forests and the off-year moso bamboo forests.

In this step, the pixel results may be calculated in Excel, each initial boundary line of the on-year and off-year moso bamboo forests may achieve a corresponding intersecting pixel result, lines which do not meet boundary line difference threshold results are eliminated, then, the results are linked into ArcGIS, and the final boundary line of the on-year moso bamboo forests and the off-year moso bamboo forests may be extracted out.

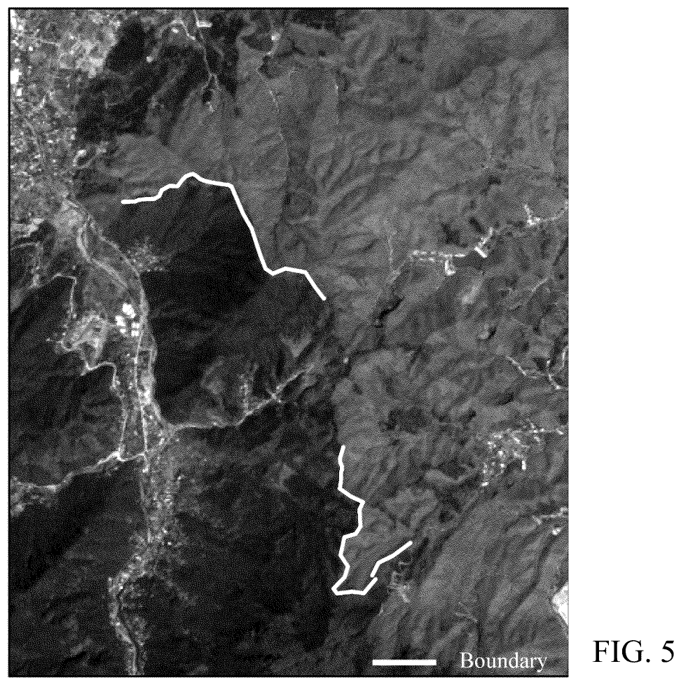

In order to verify the accuracy of the obtained final boundary line of the on-year moso bamboo forests and the off-year moso bamboo forests, the method in another embodiment, in addition to the above steps, further includes:
Step e: the extracted boundary line data and high resolution images of the Google Earth Pro software are overlapped, verification and local modification are performed, and the data is refined to obtain a final on-year and off-year boundary line result of the moso bamboo forests. In this embodiment, 158 boundary line data are finally extracted, as shown in FIG. 5.

In order to better apply the obtained boundary line result of the on-year and off-year moso bamboo forests, the method in other embodiments further includes: horizontal landscape analysis is performed by using the final boundary line of the on-year moso bamboo forests and the off-year moso bamboo forests.

The operation specifically includes:
Step f: the horizontal landscape analysis is performed by using the final boundary line of the on-year moso bamboo forests and the off-year moso bamboo forests.

Specifically, digital altitude data with a spatial resolution being 30 m in remote sensing data may be acquired, and the altitude data is subjected to slope and aspect information extraction. Additionally, boundary line vector data of on-year and an off-year moso bamboo forests is converted into point data, and altitude, slope and aspect information of each point distribution on the boundary line may be acquired by using a spatial analyst tool of ArcGIS. The altitude and slope data is respectively reclassified, the altitude is sequentially classified at an interval of 5 m, the slope is classified at an interval of 1°, the aspect is classified into 8 types at an interval of 45° azimuth angle, e.g., a northeastern slope (22.5° to) 67.5°, an eastern slope (67.5° to) 112.5°, a southeastern slope SE (112.5° to) 157.5°, and the like are acquired, and so on. The reclassified topographic data is utilized, the frequency distribution of the altitude and slope of the boundary line of the on-year and off-year moso bamboo forests in different aspects is counted by a spatial analysis method of ArcGIS, and changing features are analyzed.

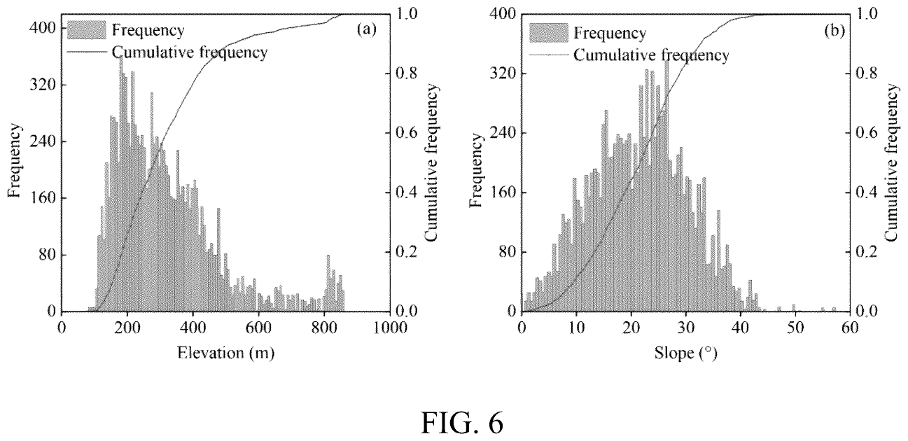

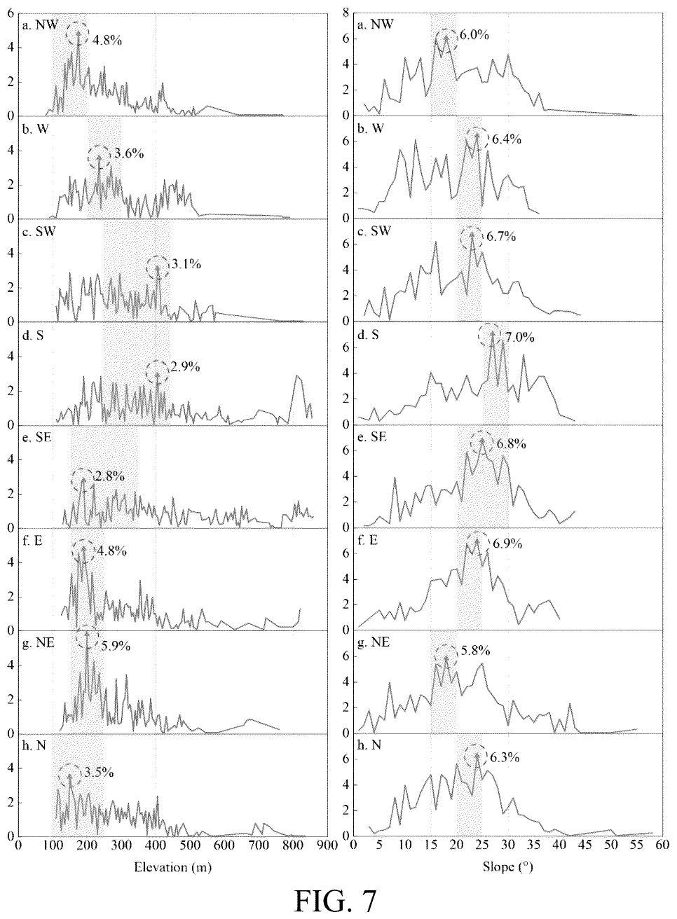

In this implementation, the boundary line of the on-year and off-year moso bamboo forests may be subjected to vertical landscape analysis, and the analysis may be performed according to practical condition to better meet the practical conditions. In this implementation, the general distribution change of the boundary line at the altitude and slope and the frequency distribution of the boundary line altitude and slope in different aspects are analyzed, as shown in FIG. 6 and FIG. 7.
Step g: the horizontal landscape analysis is performed by using the final boundary line of the on-year moso bamboo forests and the off-year moso bamboo forests.

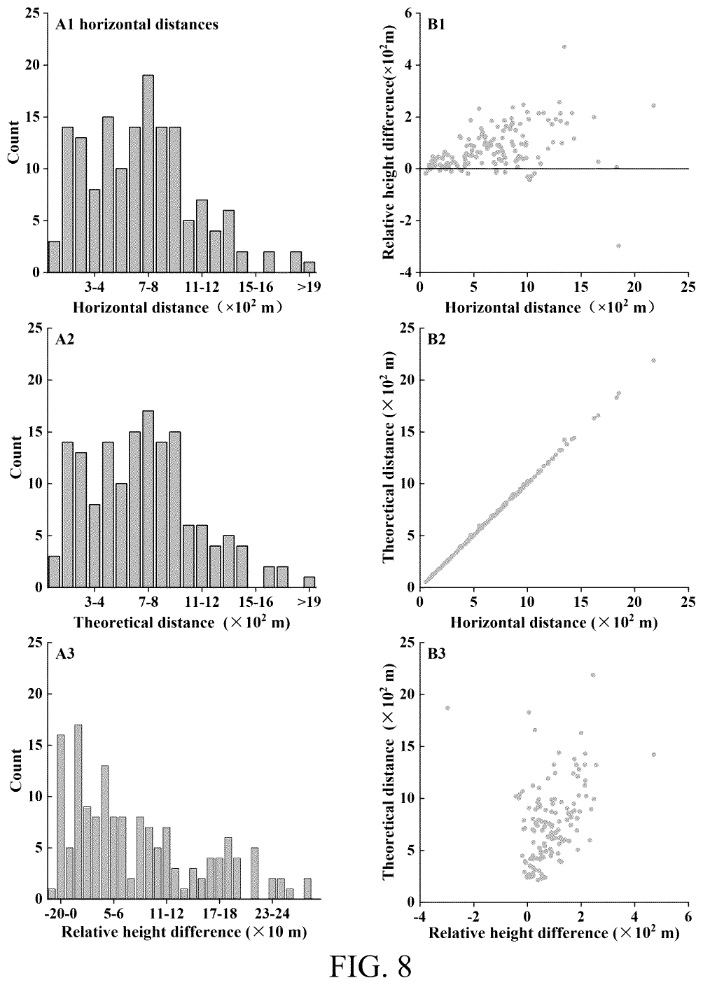

Specifically, altitude data of remote sensing images is acquired, and altitude information of residential areas is extracted from the altitude data. Residential area distribution data and the altitude data are overlapped to acquire altitude information of the residential areas. Altitude information of a lowest point of the boundary line is extracted, and a relative height difference H of the lowest point of the boundary line and a nearest residential area is calculated. A horizontal distance L between an altitude lowest point of the boundary line to the nearest residential area is acquired by using a near tool of ArcGIS. The altitude information, the relative height difference H and the horizontal distance L from the residential area may be subjected to horizontal landscape boundary line data analysis to calculate a theoretical distance between the lowest point of the boundary line and the residential area and to analyze the height difference and the distance between the boundary line and the residential area. If the height difference and the distance between the boundary line distribution and the residential area are small, whether the formation of the boundary line of the on-year and off-year moso bamboo forests is influenced by human activities or not may be further analyzed. The specific results are as shown in FIG. 8. A calculation formula of a theoretical distance S is as follows:

$$S = \sqrt{{H}^{2} + {L}^{2}}$$

In the formula, H is a relative height difference of the lowest point of the boundary line and the nearest residential area, and L is a horizontal distance from the altitude lowest point of the boundary line to the nearest residential area.

Each embodiment in this specification is described in a progressive manner, and each embodiment focuses on its differences from other embodiments. For the same and similar parts, each embodiment may be referred to each other. For the device disclosed by the embodiments, because it corresponds to the method disclosed by the embodiments, the description is relatively simple, and the relevant points may be referred to descriptions in the method section.

The above descriptions of the disclosed embodiments enable persons skilled in the art to realize or use the disclosure. Various modifications to these embodiments will be apparent to those skilled in the art, and general principles defined herein may be realized in other embodiments without departing from the spirit or scope of the disclosure. Therefore, the disclosure will not be limited to these embodiments shown herein, but will conform to the widest range consistent with the principles and novel features disclosed herein.

What is claimed is:

1. A method for extracting a boundary line of on-year and off-year moso bamboo forests based on Sentinel-2 remote sensing data, comprising the following steps:
classifying remote sensing images of regions to be extracted to acquire spatial distribution regions of three land type results, the three land type results comprising several on-year moso bamboo forests, several off-year moso bamboo forests and other vegetations between the on-year moso bamboo forests and the off-year moso bamboo forests;
extracting an initial boundary line of the on-year moso bamboo forests and the off-year moso bamboo forests according to the spatial distribution regions of three land type results;
building a buffer region of the initial boundary line, and acquiring intersecting pixels of the buffer region and the spatial distribution regions of three land type results; and
calculating pixel thresholds by using the intersecting pixels, and acquiring a final boundary line of the on-year moso bamboo forests and the off-year moso bamboo forests according to pixel threshold results.

2. The method for extracting a boundary line of on-year and off-year moso bamboo forests based on Sentinel-2 remote sensing data according to claim 1, wherein the classifying remote sensing images of regions to be extracted to acquire spatial distribution regions of three land type results specifically comprises:
acquiring multi-period remote sensing images of the regions to be extracted for two consecutive years, and performing preprocessing, the preprocessing comprising radiometric calibration, atmospheric correction, waveband resampling, waveband fusion and boundary clipping;
according to the preprocessed multi-period remote sensing images, respectively calculating a Normalized Difference Vegetation Index (NDVI) of each period of remote sensing images, counting a ratio of number of occurrences of regions with NDVI values being greater than a set threshold in each period of remote sensing images, and if the ratio is greater than a preset value, dividing corresponding regions in the remote sensing images into a spatial distribution region of evergreen vegetations;
for the spatial distribution region of evergreen vegetations, selecting images in May to calculate an OYML index and an FYML index of the remote sensing images, specifically comprising:
$$OYML = {( VRE {2}_{i - 1} - VRE {2}_{i} )}^{2} \times \frac{VRE {2}_{i} + VRE {3}_{i}}{VRE {2}_{i - 1} + VRE {3}_{i - 1}}$$
$$FYML = {( VRE {2}_{i - 1} - VRE {2}_{i} )}^{2} \div \frac{VRE {2}_{i} + VRE {3}_{i}}{VRE {2}_{i - 1} + VRE {3}_{i - 1}}$$
wherein in the formulas, VRE2; represents reflectivity of red edge 2 band in same-period remote sensing images in i^{th} year; VRE2-1 represents reflectivity of red edge 2 band in same-period remote sensing images in (i−1)^{th} year; VRE3; represents reflectivity of red edge 3 band in same-period remote sensing images in i^{th} year; and VRE3ᵢ₋₁ represents reflectivity of red edge 3 band in same-period remote sensing images in (i−1)^{th} year;
determining spatial distribution regions with the OYML index being greater than 0.01 in same-period remote sensing images in i^{th} year as regions of on-year moso bamboo forests;
determining spatial distribution regions with the FYML index being greater than 0.01 in the same-period remote sensing images in i^{th} year as regions of off-year moso bamboo forests;
and determining spatial distribution regions meeting 0.005<OYML<0.01 and 0.005<FYML<0.01 in the same-period remote sensing images in i^{th} year as regions of other vegetations.

3. The method for extracting a boundary line of on-year and off-year moso bamboo forests based on Sentinel-2 remote sensing data according to claim 1, wherein the extracting an initial boundary line of the on-year moso bamboo forests and the off-year moso bamboo forests according to the spatial distribution regions of three land type results specifically comprises:
acquiring raster data of the spatial distribution regions of three land type results;
merging raster data of the on-year moso bamboo forests and raster data of other vegetations;
converting the merged raster data and raster data of the off-year moso bamboo forests into vector data through spatial data processing;
acquiring coincidence lines of merged vector data and line vector data of the off-year moso bamboo forests; and
extracting a center line of the acquired coincidence lines, and eliminating interfering coincidence lines to acquire the initial boundary line of the on-year moso bamboo forests and the off-year moso bamboo forests.

4. The method for extracting a boundary line of on-year and off-year moso bamboo forests based on Sentinel-2 remote sensing data according to claim 1, wherein the calculating pixel thresholds by using the intersecting pixels, and acquiring a final boundary line of the on-year moso bamboo forests and the off-year moso bamboo forests according to pixel threshold results specifically comprises:
respectively acquiring areas of the intersecting pixels of the three land type results and the buffer region;
calculating the pixel thresholds according to the areas of the intersecting pixels:
$$Δ {S}_{on - off 1} = \frac{a + b}{a + b + c}$$
$$Δ {S}_{on - off 2} = \frac{b}{c}$$
wherein in the formulas, ΔS_{on-off1} represents a first pixel threshold; ΔS_{on-off2} represents a second pixel threshold; a represents an area of intersecting pixels of the buffer region and the on-year moso bamboo forests; b represents an area of intersecting pixels of the buffer region and the off-year moso bamboo forests; and c represents an area of intersecting pixels of the buffer region and other vegetations; and
setting the first pixel threshold ΔS_{on-off1} and the second pixel threshold ΔS_{on-off2} to simultaneously meet:
determining the initial boundary line meeting ΔS_{on-off1}>0.5 and ΔS_{on-off2}>0.7 as the final boundary line of the on-year moso bamboo forests and the off-year moso bamboo forests.

5. The method for extracting a boundary line of on-year and off-year moso bamboo forests based on Sentinel-2 remote sensing data according to claim 1, wherein the acquiring a final boundary line of the on-year moso bamboo forests and the off-year moso bamboo forests according to pixel threshold results further comprises:
performing verification and local modification on the final boundary line by using boundary line data of the on-year moso bamboo forests and the off-year moso bamboo forests acquired by high resolution images of Google Earth Pro software.

6. The method for extracting a boundary line of on-year and off-year moso bamboo forests based on Sentinel-2 remote sensing data according to claim 1, further comprising:
performing vertical landscape analysis and horizontal landscape analysis by using the final boundary line of the on-year moso bamboo forests and the off-year moso bamboo forests.

7. The method for extracting a boundary line of on-year and off-year moso bamboo forests based on Sentinel-2 remote sensing data according to claim 6, wherein the performing vertical landscape analysis by using the final boundary line of the on-year moso bamboo forests and the off-year moso bamboo forests specifically comprises:
acquiring altitude data of remote sensing images, and converting the final boundary line of the on-year moso bamboo forests and the off-year moso bamboo forests into point data;
overlapping the altitude data with the point data converted from the final boundary line, and extracting topographic data of each of the point data on the final boundary line, the topographic data comprising altitude, slope and aspect;
reclassifying the topographic data; and
acquiring the reclassified topographic data, and counting the frequency distribution of the altitude and slope of each of the point data of the final boundary line in different aspects and analyzing feature changes of the topographic data by using an ArcGIS spatial analysis method.

8. The method for extracting a boundary line of on-year and off-year moso bamboo forests based on Sentinel-2 remote sensing data according to claim 6, wherein the performing horizontal landscape analysis by using the final boundary line of the on-year moso bamboo forests and the off-year moso bamboo forests specifically comprises:
acquiring altitude data of remote sensing images, and extracting altitude information of residential areas from the altitude data;
converting the final boundary line of the on-year moso bamboo forests and the off-year moso bamboo forests into point data, overlapping the converted point data with the altitude data, and extracting a lowest point on the final boundary line;
acquiring a relative height difference and a horizontal distance between the lowest point on the final boundary line and a nearest residential area; and
calculating a theoretical distance between the lowest point on the final boundary line and the residential area according to the relative height difference and the horizontal distance.
